(19) United States
(12) Patent Application Publication
(10) Pub. No.: US 2019/0118764 A1
(43) Pub. Date: Apr. 25, 2019

(54) ANTI-THEFT AUTOMOTIVE DEVICE

(71) Applicant: Eduardo Castillo, Odessa, TX (US)

(72) Inventor: Eduardo Castillo, Odessa, TX (US)

(21) Appl. No.: 16/165,657

(22) Filed: Oct. 19, 2018

Related U.S. Application Data
(60) Provisional application No. 62/574,204, filed on Oct. 19, 2017.

(51) Int. Cl. B60R 25/04; B60R 25/33; B60R 25/40; F02D 29/02; F02P 11/04; F02N 11/10

(52) U.S. Cl. CPC B60R 25/04; B60R 25/33; B60R 25/403; B60R 2325/207; F02P 11/04; F02N 11/101; F02D 29/02

(57) ABSTRACT

An anti-theft automotive device is a solid state electronic circuit disabler, a transreceiver, and a dashboard visual display each having inputs and outputs that are wired into a vehicle's GPS and starting circuits that together will disable the vehicle starting circuit in the event that the GPS unit is disabled and/or an attempt to start the vehicle without the key is made. The system may be adapted to connect into any vehicle utilizing GPS tracking technology for effective theft deterrence.

### CROSS-REFERENCE TO RELATED APPLICATION

The present application is related to and claims priority from prior provisional application Ser. No. 62/574,204, filed Oct. 19, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of theft prevention devices and more specifically relates to an anti-theft automotive device.

### 2. Description of the Related Art

Motor vehicle theft or grand theft auto is the criminal act of stealing or attempting to steal any motor vehicle, usually an automobile. Nationwide in the US in 2012, there were an estimated 721,053 motor vehicle thefts, or approximately 229.7 motor vehicles stolen for every 100,000 inhabitants. Property losses due to motor vehicle theft in 2012 were estimated at 4.3 billion. There are various methods of prevention to reduce the likelihood of a vehicle getting stolen. These include physical barriers, which make the effort of stealing the vehicle more difficult. Some of these include devices used to lock a part of the vehicle necessary in its operation, such as the wheel, steering wheel or brake pedal. A commonly used device of this kind is the steering-wheel lock (also known as a crook lock or club lock). Immobilizers are used to allow the vehicle to start only if a key containing the correct chip is present in the ignition. These work by locking the steering wheel and disabling the ignition. There are hidden kill switches that cut electric current to the ignition coil, fuel pump, or other system to frustrate or slow down a thief and discourage their choice for theft. Deterrents tell the thief they are more likely to get caught if the vehicle is stolen. These devices or methods include car alarm systems that are triggered by breaking and entry into the vehicle, microdot identification tags that allow individual parts of a vehicle to be identified, and signs on the vehicle windows warning of other deterrents, sometimes as a bluff. VIN etching may also reduce the resale value of parts or increase risk of resale.

Recovery rates for stolen vehicles vary, depending on the effort a jurisdiction's police department puts into recovery, and devices a vehicle has installed to assist in the process. Police departments use various methods of recovering stolen vehicles, such as random checks of vehicles that come in front of a patrol unit, checks of all vehicles parked along a street or within a parking lot using automatic number plate recognition (ANPR) or keeping a watch-list of all the vehicles reported stolen by their owners. Vehicle tracking systems, such as LOJACK, automatic vehicle location, or ONSTAR, may enable the location of the vehicle to be tracked by local law enforcement or a private company. Other security devices such as microdot identification allow individual parts of a vehicle to also be identified and potentially returned.

Various attempts have been made to solve the above-mentioned problems such as those found in U.S. Pat. No. 7,027,919 to Biggs et al.; U.S. Pat. No. 5,898,391 to Jefferies et al.; U.S. Pat. No. 5,223,844 to Mansell et al.; U.S. Pub. No. 2013/0214917 to Chung et al.; U.S. Pat. No. 7,176,788 to Jong-Rae Park. None of the above inventions and patents, taken either singly or in combination, is seen to describe the invention as claimed.

Ideally, a theft prevention device should provide notification of the location of a user's vehicle at low cost as well as preventing the engine from starting without the key, and yet, would operate reliably and be manufactured at a modest expense. Thus, a need exists for a reliable anti-theft automotive device to avoid the above-mentioned problems.

### BRIEF SUMMARY OF THE INVENTION

In view of the foregoing disadvantages inherent in the known theft prevention device art, the present invention provides a novel anti-theft automotive device. The general purpose of the present invention, which will be described subsequently in greater detail, is to provide notification of the location of a user's vehicle as well as preventing the engine from starting without the key, at a low cost.

The anti-theft automotive device preferably comprises a global positioning system transceiver adapted to be attached to a vehicle, a global positioning system display adapted to be attached to the dashboard of the vehicle to display global positioning of the vehicle in real time, a power supply electrically connected to provide electric power to the global positioning system transceiver and the global positioning system display, a plurality of electrical wires with at least one of the electrical wires connected between the global positioning system transceiver and the global positioning system display, and at least one of the electrical wires is adapted to be connected between the global positioning system transceiver and an ignition relay of a vehicle. At least one of the electrical wires is connected between the global positioning system transceiver and the power supply and at least one of the plurality of electrical wires is adapted to be connected between the global positioning system transceiver and a chassis of the vehicle.

A kill switch is electrically connected to the global positioning system transceiver via one of the electrical wires and to the ignition relay, and the kill switch is adapted to control the ignition relay to selectively prevent the vehicle from starting and running. The anti-theft automotive device is adapted such that when any one of the plurality of electrical wires is disconnected, the kill switch will be activated and the vehicle will be prevented from starting and running and when the disconnected wire is reconnected the kill switch will be reactivated and the vehicle will be able to start and run again.

The global positioning system transceiver is adapted to send and receive electronic messages to and from a remote global positioning system to determine the position of the vehicle in real time. The power supply is preferably formed as a 12-volt direct current power supply.

The combination of a vehicle and an anti-theft automotive device may comprise a vehicle including a chassis, a main body having a roof portion and a dashboard with the main body connected to the chassis, a motor mounted onto the chassis, an ignition relay connected to the chassis and adapted to control the starting and stopping of the motor via a starter solenoid, at least one fuel injector, and an ignition control that is connected to the chassis that is electrically connected to and adapted to control the ignition relay and the starter solenoid. The starter solenoid is connected to and is adapted to start the motor, and the fuel injector system is connected to the chassis and is adapted to send fuel to the motor.

The anti-theft automotive device also comprises a global positioning system transceiver adapted to be attached to the vehicle, a global positioning system display adapted to be attached to the dashboard of the vehicle to display global positioning of the vehicle in real time, a power supply electrically connected to supply electric power to the global positioning system transceiver and the global positioning system display, and a plurality of electrical wires connecting the global positioning system transceiver and the global positioning system display.

At least one of the electrical wires is connected between the global positioning system transceiver and the ignition relay of the vehicle and at least one of the electrical wires is connected between the global positioning system transceiver and the power supply. At least one of the electrical wires is connected between the global positioning system transceiver and the chassis of the vehicle.

A kill switch is electrically connected to the global positioning system transceiver via one of the electrical wires and electrically connected to the ignition relay of the vehicle. The kill switch is adapted to control the ignition relay to selectively prevent the vehicle from starting and running.

The anti-theft automotive device is adapted such that when any one of the plurality of electrical wires is disconnected the kill switch will be activated and the vehicle prevented from starting and running and when the disconnected wire is reconnected the kill switch will be reactivated and the vehicle will be able to start and run again.

The global positioning system transceiver is adapted to send and receive electronic messages with a remote global positioning system to determine the position of the vehicle in real time. The global positioning system transceiver may be attached to a roof portion of the vehicle.

The power supply is preferably formed as a 12-volt direct current power supply, but in other embodiments, voltage may be reduced or transformed and it should be understood that the voltage used is not intended to be limited to an amount or a type.

The present invention holds significant improvements and serves as an anti-theft automotive device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an anti-theft automotive device, constructed and operative according to the teachings of the present invention.

FIG. 1 shows a perspective view illustrating an anti-theft automotive device according to an embodiment of the present invention.

FIG. 2 is a perspective view illustrating the anti-theft automotive device in a vehicle according to an embodiment of the present invention of FIG. 1.

FIG. 3A is a diagram illustrating the anti-theft automotive device according to an embodiment of the present invention of FIG. 1.

FIG. 3B is a flow chart illustrating the operation of the anti-theft automotive device according to an embodiment of the present invention of FIG. 1.

FIG. 4 is a side view illustrating the combination of a vehicle and an anti-theft automotive device according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a theft prevention device and more particularly to an anti-theft automotive device as used to provide notification of the location of the user's vehicle as well as preventing the engine from starting without the key at a low cost.

Generally speaking, the anti-theft automotive device is a solid state electronic circuit disabler, a transreceiver, and a dashboard visual display each having inputs and outputs that are wired into a vehicle's GPS and starting circuits that together will disable the vehicle starting circuit in the event that the GPS unit is disabled and/or an attempt to start the vehicle without the key is made. The system may be adapted to connect into any vehicle utilizing GPS tracking technology for effective theft deterrence.

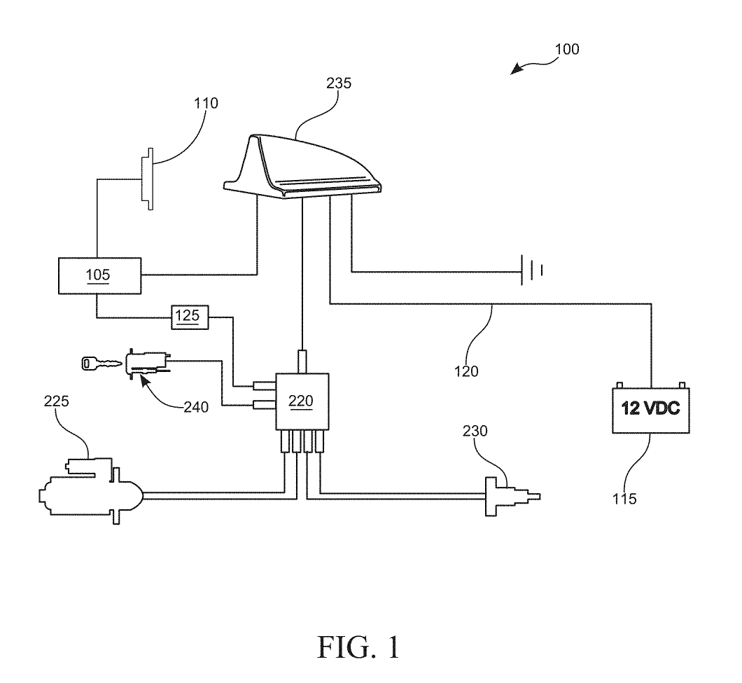

Referring to the drawings by numerals of reference there is shown in FIG. 1, a perspective view illustrating anti-theft automotive device 100 according to an embodiment of the present invention.

Anti-theft automotive device 100 preferably comprises global positioning system transceiver 105 adapted to be attached to vehicle 202, global positioning system display 110 adapted to be attached to dashboard 212 of vehicle 202 to display global positioning of vehicle 202 in real time, power supply 115 electrically connected to provide electric power to global positioning system transceiver 105 and global positioning system display 110, a plurality of electrical wires 120 with at least one of electrical wires 120 connected between global positioning system transceiver 105 and global positioning system display 110, and at least one of electrical wires 120 is adapted to be connected between global positioning system transceiver 105 and ignition relay 220 of vehicle 202. At least one of electrical wires 120 is connected between global positioning system transceiver 105 and power supply 115 and at least one of the plurality of electrical wires 120 is adapted to be connected between global positioning system transceiver 105 and chassis 205 of vehicle 202.

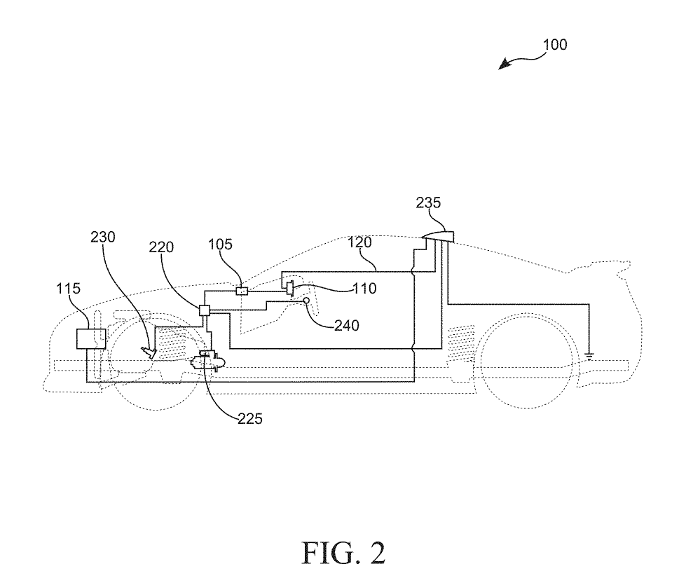

Referring now to FIG. 2, is a perspective view illustrating anti-theft automotive device 100 in vehicle 202 according to an embodiment of the present invention of FIG. 1.

Kill switch 125 is electrically connected to global positioning system transceiver 105 via one of electrical wires 120 and to ignition relay 220, and kill switch 125 is adapted to control ignition relay 220 to selectively prevent vehicle 202 from starting and running. Anti-theft automotive device 100 is adapted such that when any one of the plurality of electrical wires 120 is disconnected, kill switch 125 will be activated and vehicle 202 will be prevented from starting and running, and when the disconnected electrical wire 120 is reconnected kill switch 125 will be reactivated and vehicle 202 will be able to start and run again.

Global positioning system transceiver 105 is adapted to send and receive electronic messages to and from a remote global positioning system to determine the position of vehicle 202 in real time. Power supply 115 is preferably formed as a 12-volt direct current power supply 115.

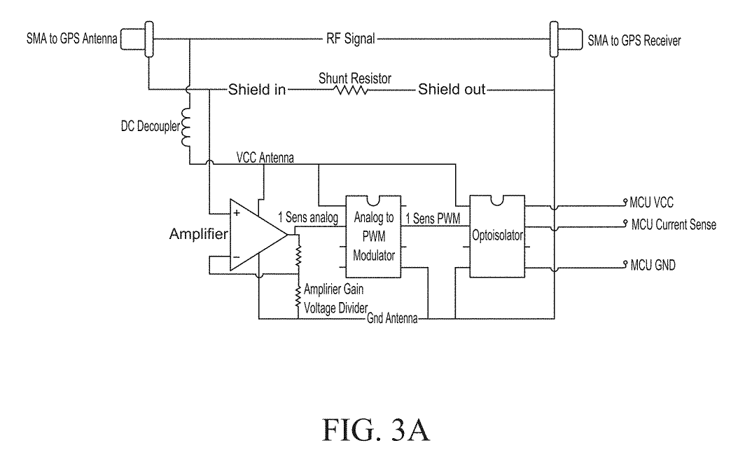

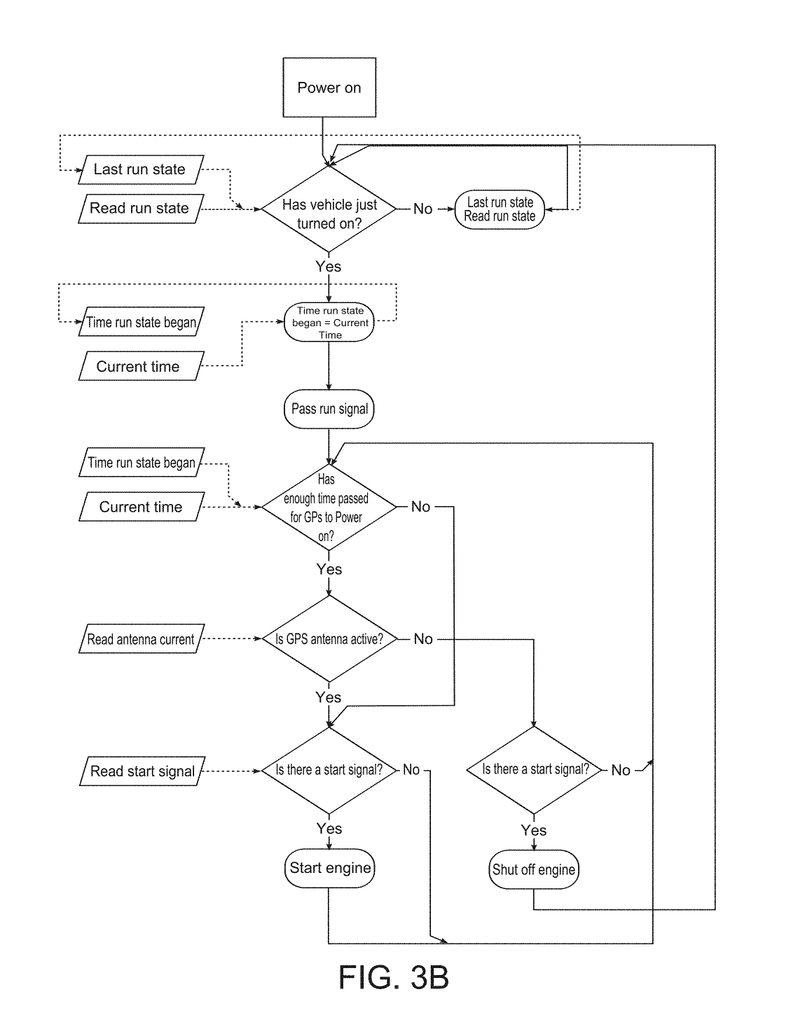

Referring now to FIG. 3A is a diagram illustrating anti-theft automotive device 100 according to an embodiment of the present invention of FIG. 1.

The primary function of the circuit of anti-theft automotive device 100 is to detect when current is passing through the active GPS antenna 235 (seen in other figs.). This is done by placing a low-side current measuring circuit inline with the ground or shield of GPS antenna 235 cable. The low side current measuring is done by measuring the voltage drop across the shunt resistor placed in series with the shield signal. The voltage across the shunt resistor is linearly proportionally to the current passing through it, and it produces a small voltage in the milliohm range.

To amplify the small signal to more useable and noise immune signal an operational amplifier is selected with low operating current and low input capacitance on the positive pin. The amplifier attempts to match the voltage on the positive pin by outputting a voltage on the output pin proportional to the differential between the positive and negative pin. The signal being fed back to the negative pin of the amplifier is the divided voltage of the output pin at a ratio set by the voltage divider circuit. The voltage divider therefore sets the gain of the amplifier and will be tuned to produce a voltage between 0 and 3.3 volts which will be proportionate to a current of 0 to 100 ma passing across the shunt resistor. In order to isolate GPS antenna 235 and current measuring circuitry from the control electronics of the invention, the current measuring circuitry must be powered by the DC power being fed to the active GPS antenna 235 by global positioning system transceiver 105, and an optoisolator must be used to relay the current sense signal between the sensing circuitry and the MCU circuitry.

To provide power to the current sensing and isolating circuits, a DC decoupling inductor must be used to block the RF signals from reaching the VCC pins of the amplifier and isolation circuitry, in the same fashion that an active GPS antenna 235 decouples RF and DC signals. In the shown schematic this is the DC decoupler placed between the RF signal and the antenna VCC.

Because optoisolators are best suited for relaying binary signals (high and low) and are less suited for directly relaying analog signals, an analog to PWM modulator IC must be used to translate the 0-3.3V being output by the amplifier circuit to a 0-100% digital pulse width to be fed into the optoisolator. As with the amplifier this part draws very little current so as to be as transparent as possible to the existing GPS antenna 235 and global positioning system transceiver 105 (seen in other figs). Voltage passes the PWM pulses at GPS antenna 235 ground potential to equal pulses at the MCU's ground potential. The optoisolator therefore requires power and ground on both GPS antenna 235 side of the circuit as well as the MCU side of the circuit.

Referring now to FIG. 3B is a flow chart illustrating the operation of anti-theft automotive device 100 according to an embodiment of the present invention of FIG. 1.

A flowchart is seen in FIG. 3B that demonstrates a typical method of operation but certain steps may be added, eliminated, or changed as needed for certain applications. The hardware included in this figure is shown in the other figures. The program on the MCU reads the PWM signal and applies an algorithm to convert the 0-100% PWM pulse width reading into 0-100 ma current measurement across the shunt resistor. The program also reads the states of the interrupted start and run signals. If the program detects that the run signal is present it will pass that run signal to the run circuitry of vehicle 202 to allow the equipped GPS tracking unit to power on and therefore power the active GPS antenna 235. The program will wait an appropriate amount of time to allow global positioning system transceiver 105 to power GPS antenna 235. The program will let vehicle 202 start if it is before the amount of time required for the GPS to power on but will shut it off if that amount of time has passed and no GPS antenna 235 is detected. Conversely, if GPS antenna 235 is detected it will let vehicle 202 start and run.

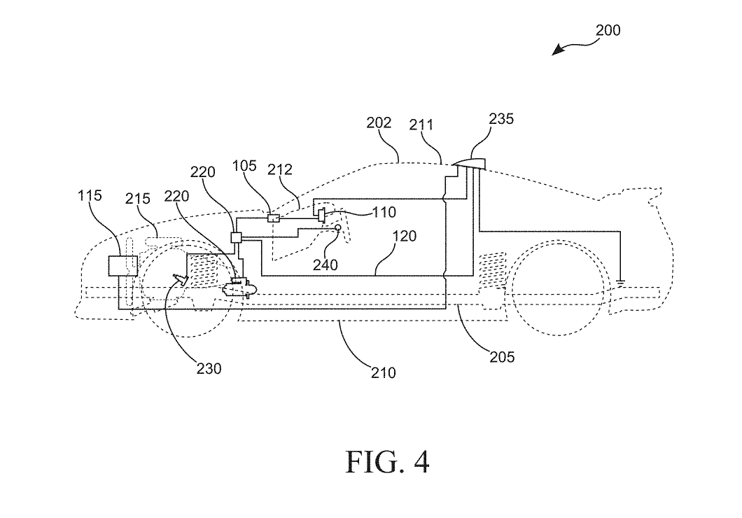

Referring now to FIG. 4, is a side view illustrating combination of a vehicle and an anti-theft automotive device 200 according to an embodiment of the present invention of FIG. 1.

Combination of a vehicle and an anti-theft automotive device 200 may comprise vehicle 202 including chassis 205, main body 210 having roof portion 211 and dashboard 212 with main body 210 connected to chassis 205, motor 215 mounted onto chassis 205, ignition relay 220 connected to chassis 205 and adapted to control the starting and stopping of motor 215 via starter solenoid 225, at least one fuel injector 230, and ignition control 240 that is connected to chassis 205 that is electrically connected to and adapted to control ignition relay 220 and starter solenoid 225. Starter solenoid 225 is connected to and is adapted to start motor 215, and fuel injector 230 system is connected to chassis 205 and is adapted to send fuel to motor 215.

Anti-theft automotive device 100 also comprises global positioning system transceiver 105 adapted to be attached to vehicle 202, global positioning system display 110 is adapted to be attached to dashboard 212 of vehicle 202 to display global positioning of vehicle 202 in real time, power supply 115 electrically connected to supply electric power to global positioning system transceiver 105 and global positioning system display 110, and a plurality of electrical wires 120 connecting global positioning system transceiver 105 and global positioning system display 110.

At least one of electrical wires 120 is connected between global positioning system transceiver 105 and ignition relay 220 of vehicle 202 and at least one of electrical wires 120 is connected between global positioning system transceiver 105 and power supply 115. At least one of electrical wires 120 is connected between global positioning system transceiver 105 and chassis 205 of vehicle 202.

Kill switch 125 is electrically connected to global positioning system transceiver 105 via one of electrical wires 120 and electrically connected to ignition relay 220 of vehicle 202. Kill switch 125 is adapted to control ignition relay 220 to selectively prevent vehicle 202 from starting and running.

Anti-theft automotive device 100 is adapted such that when any one of the plurality of electrical wires 120 is disconnected kill switch 125 will be activated and vehicle 202 prevented from starting and running and when the disconnected electrical wire 120 is reconnected, kill switch 125 will be reactivated and vehicle 202 will be able to start and run again.

Global positioning system transceiver 105 is adapted to send and receive electronic messages with a remote global positioning system to determine the position of vehicle 202 in real time. Global positioning system transceiver 105 may be attached to roof portion 211 of vehicle 202.

Power supply 115 is preferably formed as a 12-volt direct current power supply 115, but in other embodiments, voltage may be reduced or transformed and it should be understood that the voltage used is not intended to be limited to an amount or a type.

Anti-theft automotive device 100 may be sold as a kit comprising the following parts: at least one global positioning system transceiver 105; at least one global positioning system display 110; at least one kill switch 125; at least one electrical wire 120; at least one power supply 115; and at least one set of user installation instructions. The kit has instructions such that functional relationships are detailed in relation to the structure of the invention (such that the invention can be used, maintained, or the like in a preferred manner). Anti-theft automotive device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

It should be noted that the steps described in the method of operation may be carried out in many different orders according to user preference. The use of the term “step of” should not be interpreted as “step for”, in the claims herein and is not intended to invoke the provisions of 35 U.S.C. § 112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within the flowchart, elimination or addition of certain steps, may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An anti-theft automotive device comprising:
a global positioning system transceiver;
wherein said global positioning system transceiver is adapted to be attached to a vehicle;
a global positioning system display;
wherein said global positioning system display is adapted to be attached to a dashboard of said vehicle and display global positioning of said vehicle in real time;
a power supply;
wherein said power supply is electrically connected to and supplies electric power to said global positioning system transceiver and said global positioning system display;
a plurality of electrical wires;
wherein one of said plurality of electrical wires is connected between said global positioning system transceiver and said global positioning system display;
wherein one of said plurality of electrical wires is adapted to be connected between said global positioning system transceiver and an ignition relay of said vehicle;
wherein one of said plurality of electrical wires is connected between said global positioning system transceiver and said power supply; and
wherein one of said plurality of electrical wires is adapted to be connected between said global positioning system transceiver and a chassis of said vehicle; and
a kill switch;
wherein said kill switch is electrically connected to said global positioning system transceiver via one of said plurality of electrical wires, and is adapted to be electrically connected to said ignition relay via one of said plurality of electrical wires; and
wherein said kill switch is adapted to control said ignition relay to selectively prevent said vehicle from starting and running;
wherein said anti-theft automotive device is adapted such that when any one of said plurality of electrical wires is disconnected said kill switch will be activated and said vehicle prevented from starting and running; and wherein when said disconnected wire is reconnected said kill switch will be reactivated and said vehicle will be able to start and run again.

2. The anti-theft automotive device of claim 1, wherein said global positioning system transceiver is adapted to send and receive electronic messages to and from a remote global positioning system to determine the position of said vehicle in real time.

3. The anti-theft automotive device of claim 1, wherein said power supply is formed as a 12-volt direct current power supply.

4. A combination of a vehicle and an anti-theft automotive device comprising:
a vehicle including:
a chassis;
a main body including:
a roof portion; and
a dashboard;
wherein said main body is connected to said chassis;
a motor;
wherein said motor is connected to said chassis;
an ignition relay;
wherein said ignition relay is connected to said chassis and adapted to control the starting and stopping of said motor via a starter solenoid and a fuel injector;
an ignition control;
wherein said ignition control is connected to said chassis, and is electrically connected to and adapted to control said ignition relay;
a starter solenoid;
wherein said starter solenoid is connected to said chassis, and is mechanically connected to and adapted to start said motor;
a fuel injector;
wherein said fuel injector is connected to said chassis, and is connected to and adapted to send fuel to said motor; and
an anti-theft automotive device comprising:
a global positioning system transceiver;
wherein said global positioning system transceiver is adapted to be attached to said vehicle;
a global positioning system display;
wherein said global positioning system display is adapted to be attached to said dashboard of said vehicle and display global positioning of said vehicle in real time;
a power supply;
wherein said power supply is electrically connected to and supplies electric power to said global positioning system transceiver and said global positioning system display;
a plurality of electrical wires;
wherein one of said plurality of electrical wires is connected between said global positioning system transceiver and said global positioning system display;
wherein one of said plurality of electrical wires is connected between said global positioning system transceiver and said ignition relay of said vehicle;
wherein one of said plurality of electrical wires is connected between said global positioning system transceiver and said power supply; and
wherein one of said plurality of electrical wires is connected between said global positioning system transceiver and said chassis of said vehicle; and
a kill switch;
wherein said kill switch is electrically connected to said global positioning system transceiver via one of said plurality of electrical wires, and is electrically connected to said ignition relay of said vehicle via one of said plurality of electrical wires; and
wherein said kill switch is adapted to control said ignition relay to selectively prevent said vehicle from starting and running;
wherein said anti-theft automotive device is adapted such that when any one of said plurality of electrical wires is disconnected said kill switch will be activated and said vehicle prevented from starting and running; and wherein when said disconnected wire is reconnected said kill switch will be reactivated and said vehicle will be able to start and run again.

5. The combination of claim 4, wherein said global positioning system transceiver is adapted to send and receive electronic messages with a remote global positioning system to determine the position of said vehicle in real time.

6. The combination of claim 4, wherein said global positioning system transceiver is attached to said roof portion of said vehicle;

7. The combination of claim 4, wherein said power supply is formed as a 12-volt direct current power supply.
